(19) United States
(12) Patent Application Publication
(10) Pub. No.: US 2009/0234654 A1
(43) Pub. Date: Sep. 17, 2009

(54) TEXT PARSER

(76) Inventor: Anand Balaji Ramakrishnan, Houston, TX (US)

Correspondence Address: ANAND RAMAKRISHNAN, 12831 WOODLITE LN., HOUSTON, TX, 77015, US

(21) Appl. No.: 12/046,379

(22) Filed: Mar. 11, 2008

(51) Int. Cl. G10L 11/00; G06F 17/30

(52) U.S. Cl. 704/270; 707/3; 707/E17.014; 704/E11.001

(57) ABSTRACT

Embodiments of the present invention provide techniques for processing of patents. Similar words to each word in a claim may be found to words in a patent document. Often the words of the claims may be searched for in a cited reference to flag to the practitioner an area of interest that may contain a paragraph or sentence that may disclose that feature of a claim. An automated method of searching for similar words of a claim that notify a practitioner of an area of patentable interest is presented in some embodiments of this invention.

### BACKGROUND OF THE INVENTION

1. Field of the Invention

Embodiments of the present invention generally relate to parsing of information.

2. Description of the Related Art

Claims are arguably the most important part of a patent. During their examination, prosecution, or litigation, the analysis of the claims of a patent or a patent application is very important.

For example, for the Examiner to reject a claim, all claim features must be taught in a reference. An Examiner might reject a claim because all the features of a claim are taught or suggested in one or more references. Additionally, an Examiner might reject a claim because not all the claims are supported in the patent applications specification.

A technique is needed to identify areas in a claim that may be of concern to in the prosecution or litigation of a patent.

### BRIEF DESCRIPTION OF THE DRAWINGS

So that features of the present invention can be understood in detail, a particular description of the invention may be had by reference to embodiments, some of which are illustrated in the appended drawings. It is to be noted, however, that the appended drawings illustrate only typical embodiments of this invention and are therefore not to be considered limiting of its scope, for the invention may admit to other equally effective embodiments.

FIG. 1 is a view of a computer system according to an embodiment of the invention.

FIG. 2 is a flow chart of example operations for stream processing.

FIG. 3A-3B are a view of stream processing according to an embodiment of the invention.

FIG. 4A-4B illustrate stream processing according to an embodiment of the invention.

### DETAILED DESCRIPTION OF THE PREFERRED EMBODIMENTS

Embodiments of the present invention provide techniques for processing of patents. Similar words to each word in a claim may be found to words in a patent document. Often the words of the claims may be searched for in a cited reference to flag to the practitioner an area of interest that may contain a paragraph or sentence that may disclose that feature of a claim. An automated method of searching for similar words of a claim that notify a practitioner of an area of patentable interest is presented in some embodiments of this invention.

### Example Network Topology

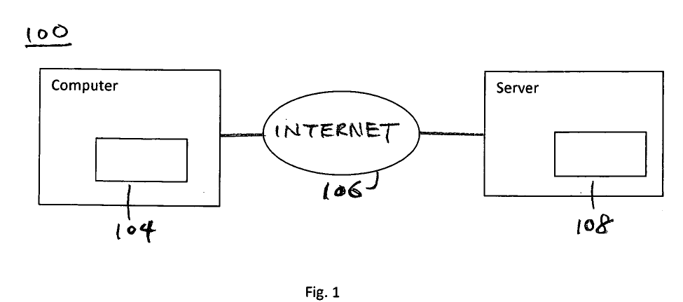

FIG. 1 illustrates an example computer system 100 in which the embodiments of the present invention may be utilized. A computer 102 with memory 104 may be connected to the Internet 106. The Internet 106 may be connected to a server 108 that serves web pages to different locations on the Internet 106. A document may reside on the memory 104 or the server 108. The document may be a patent document.

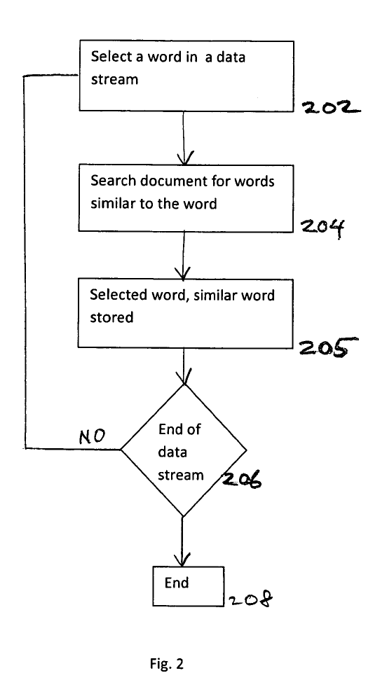

In some embodiments, all the operations of FIG. 2 may occur on the server 108 while a user operates the computer 102. In some embodiments, all the operations of FIG. 2 may occur on the computer 102. In this embodiment, documents to be used as a data stream may download from the Internet 106 while processed on the computer 102.

### Determining Similarity

FIG. 2 illustrates example operations 200 for finding similar words in a document. The operations begin at 202 where a word is selected from a data stream. The data stream may some or all of the text of a patent document. The data stream may be the claims of a patent or patent application. The data stream may be the text of multiple patent documents in one data stream. This may be useful in processing obviousness-type rejections which may include several references.

At 204, the document is searched for words similar to the selected word of the data stream. A word may be considered similar if it has a percentage of the same letters of the selected words as described below. At 205, the selected word and similar word or words may be stored.

At 206, if it is determined that the end of the data stream has been reached then at 208, the process stops. If not, at 202, another word is selected from the data stream. The word selected may be out of order within the data stream.

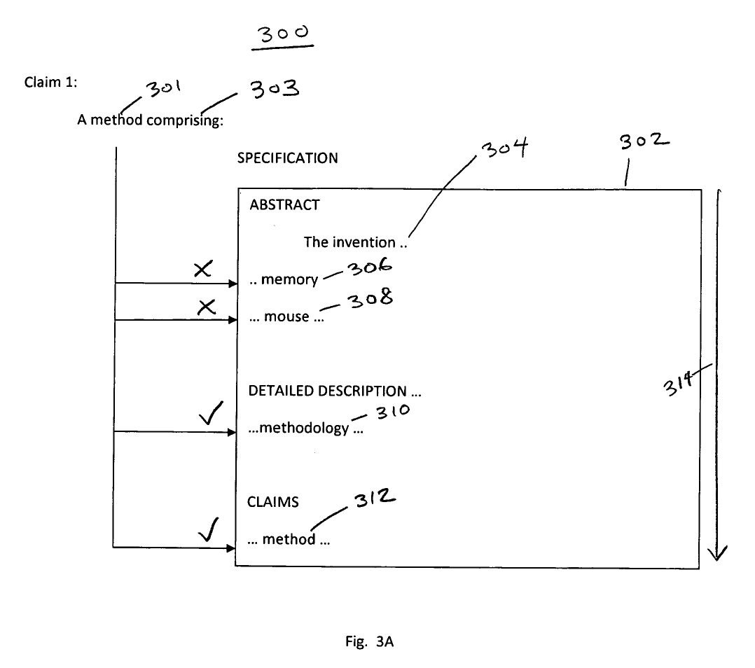

FIG. 3A illustrates data stream processing according to an embodiment of the invention. A selected word 301 of a claim may be compared against words in a patent document such as a specification 302. The specification 302 may be stored in a data stream 314. The data stream 314 may be all the text of the specification 302. After a selected word 301 is selected it is compared against streamed words 306, 308, 310, and 312, “memory,” “mouse,” “methodology,” and “method,” respectfully. A streamed word 306, “memory,” may not be similar enough to be similar to “method,” the selected word 301 (as with streamed word 308). However, a streamed word 310 “methodology” may be determined to be similar to “method” (as with streamed word 312).

Requiring the selected word to be the exact word may be problematic because sometimes an area or word of a specification may be important, but may not be the exact spelling of the selected word. For example, if the selected word is “finding,” then the streamed word “find” while not an exact spelling of “finding” may still be an area of interest in the document. To solve this problem an exact match of the selected word with the streamed word may not be necessary for a similarity determination.

In some embodiments, a selected word may be determined to be similar to a streamed word if most of the letters of the selected word occur, in order, in the streamed word. In some embodiments, the location of a streamed word determined to be similar to a selected word may be stored. The location stored may be the location in the data stream or the original patent document.

In some embodiments, the determination of similarity may be due to a requirement that a certain percentage of letters in the selected word appear in the streamed word. For example, if 40% of the selected word 301's letters are required to be in the streamed word, the streamed word 310 would be determined to be similar because greater than 46% of the letters of ‘METHOD” are founding “METHODOLOGY.” However, streamed word 306 may not be determined to be similar because only the letters M-E-O are in “METHOD” and “MEMORY.”

In some embodiments, a function for computing similarity may be provided. The above determination of similarity may occur as described in 204 above. After the determination is complete for selected word 301, the determination may be performed by the selection of the next selected word 303 “comprising.”

FIG. 3B illustrates stream processing according to an embodiment of the invention. A similar word location 405 may be associated with a similar word 404. The similar word location 405, 406 may be the location of an occurrence of the similar word 404 in the data stream or in the patent document. There may be more than one similar word per selected word. For example, the selected word 402 may be similar to similar words 404, and 407. Also, each similar word may have one or more similar word locations associated with the similar word. For example, the similar word 404 may be associated with similar word locations 405, 406.

The display of the selected words, similar words, and the similar word locations as in FIG. 3B may facilitate a person analyzing where a claim's features might be disclosed in a patent document. A practitioner may easily look to see where part of a claim, here the selected word 402, may be disclosed in a reference, here similar word locations 405, 406. The selected word locations 405, and 406 may provide information that discloses the feature “method.” If it does not, the practitioner has, at least been notified of a possible area of interest in the patent or patent document.

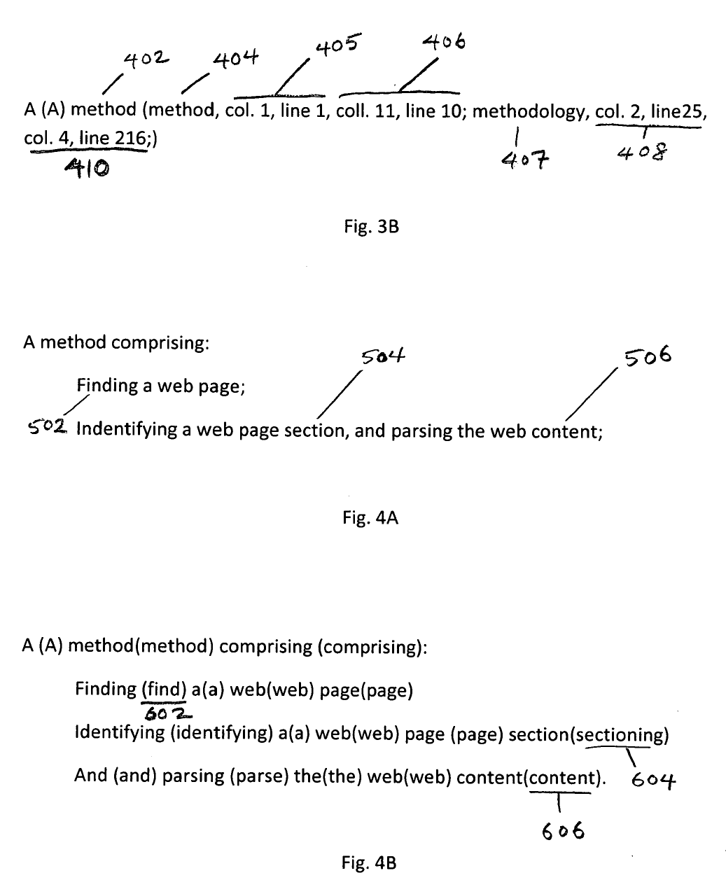

FIG. 4A-4B illustrate stream processing according to an embodiment of the invention. FIG. 4A shows information in a data stream with selected words 502, 504, and 506 which may be processed as described in FIG. 2 above. FIG. 4B shows another form of output as an alternative to FIG. 3B which displays location information. Each selected word 502, 504, and 506 may be displayed with a corresponding similar word 602, 604, and 606. The similar words may be displayed in a different color than the selected words. The similar word displayed such as 602, 604 and 606 may be the first similar word found in a document using a method described above.

While the foregoing is directed to embodiments of the present invention, other and further embodiments of the invention may be devised without departing from the basic scope thereof, and the scope thereof is determined by the claims that follow.

1. A method comprising:
selecting a word in a data stream;
searching a document for one or more similar words similar to the word; and
storing the word and the one or more similar words.

2. The method of claim 1 wherein the determination of similarity is based on a comparison between part of the word and part of one or more words in the document.

3. The method of claim 1 wherein the word and the one or more similar words are outputted to a display device sequentially according to their order of appearance in the document.

4. An apparatus comprising:
processing logic configured to select a word in a data stream; search a document for one or more similar words similar to the word; and store the word and the one or more similar words.
